(19) United States
(12) Patent Application Publication
(10) Pub. No.: US 2013/0325601 A1
(43) Pub. Date: Dec. 5, 2013

(54) SYSTEM FOR PROVIDING CONTENT

(71) Applicants: Ajay Shekhawat, San Francisco, CA (US); Adam Cahan, San Francisco, CA (US)

(72) Inventors: Ajay Shekhawat, San Francisco, CA (US); Adam Cahan, San Francisco, CA (US)

(73) Assignee: Yahoo! Inc., Sunnyvale, CA (US)

(21) Appl. No.: 13/488,542

(22) Filed: Jun. 5, 2012

(51) Int. Cl. G06Q 30/02

(52) U.S. Cl. 705/14.49

(57) ABSTRACT

A computer-implemented method serves content to a device. The method includes identifying a characteristic of content displayed with a first device. Through the use of a processor, the characteristic is compared with a campaign constraint of an advertising campaign that includes an advertisement. The method includes transmitting the advertisement to a second device for display when the characteristic satisfies the campaign constraint.

### TECHNICAL FIELD

The present description relates generally to a system and method, generally referred to as a system, for providing content. More specifically, the present description relates to a system for providing additional content to a device based on content being displayed to a user.

### BACKGROUND

The evolution of electronic and communications technology allows users to interact with networks and each other faster and in more ways than ever before. Users may, for example, own and operate multiple electronic devices configured to provide personal, business, and/or entertainment content to operating users.

### SUMMARY

A computer-implemented method serves content to a device. The method includes identifying a characteristic of content displayed with a first device. Through the use of a processor, the characteristic is compared with a campaign constraint of an advertising campaign that includes an advertisement. The method includes transmitting the advertisement to a second device for display when the characteristic satisfies the campaign constraint.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of an example user environment.

FIG. 2 is a block diagram of an example network environment.

FIG. 3 is a block diagram of an example system for providing content.

FIG. 4 is a block diagram of an example network environment.

FIG. 5 is a block diagram of an example network environment.

FIG. 6 is a flow diagram of an example method of providing content.

FIG. 7 is a flow diagram of an example method of providing content.

FIG. 8 is a flow diagram of an example method of providing content.

FIG. 9 is a block diagram of an example processing system for use with the systems and methods for providing content.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

One or more electronic devices may be configured or operable to provide content to a user. In some instances and environments, a user may operate one or more electronic devices at the same time. Multiple electronic devices may each provide content to the user simultaneously or contemporaneously.

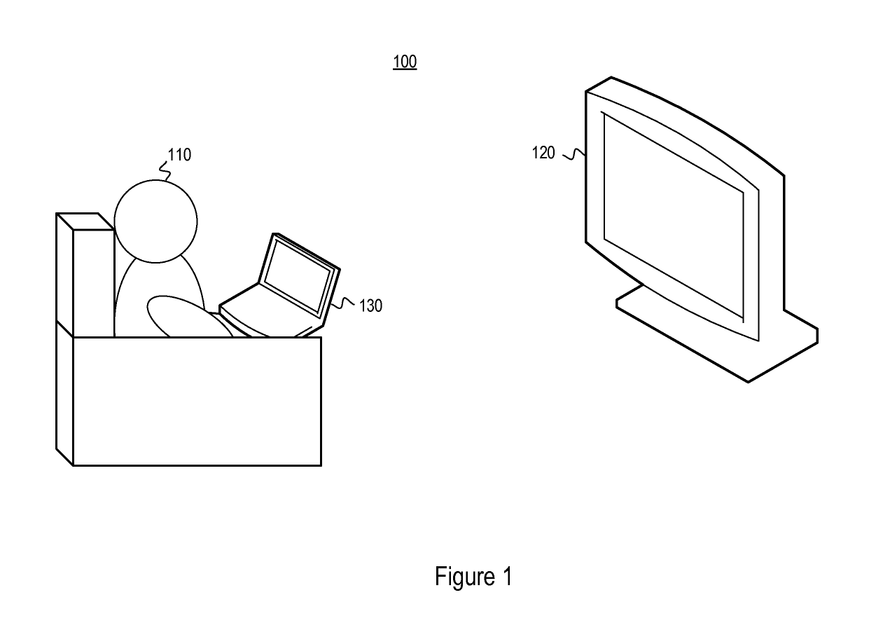

FIG. 1 is a diagram of an example user environment 100 for a user 110 with multiple electronic devices. The user 110 may be any person, business, machine, entity, or various other objects or users.

The user environment 100 may two or more electronic devices, such as a television 120 and a laptop computer 130. While the electronic devices shown in the user environment 100 are a television 120 and a laptop 130, other environments, systems, or networks may also or alternatively include one or more other electronic devices, such as a tablet device, a smart phone, a mobile phone, a cellular phone, a processor, a computer, a server, a personal digital assistant (“PDA”), pager, network-enabled television or other television, digital video recorder, such as TIVO®, automobile, television, appliance or platform capable of data communications, a Global Positioning System (“GPS”) devices, gaming systems, or one or more other devices. Various numbers of electronic devices may be included in a user environment 100.

The electronic devices, such as the television 120 and the laptop 130, may provide content to the user 110. Content may be or include various forms of information, data, or signals, such as audio data, images, video data, textual data, or various other data. For example, content may be or include part or all of a television program, television show, television event, radio show, radio program, radio event, audio advertisement, video or image advertisement, textual advertisement, other advertisements, web page, web site, online content, article or paper, data or information from or associated with social networking, or various other audio, video, image, or textual data, signals, or information. Content may be processed in the form of physical signals, such as electrical signals, for example, may be stored in memory, as physical states, for example, or may be processed or stored in various other ways. The content may be transmitted, provided, or displayed to the user through or using a variety of electronic media, networks, and formats.

The user 110 may receive content at the same time or contemporaneously from two or more electronic devices, such as from both the television 120 and the laptop 130. For example, the user 110 may watch a television program or event on the television 120, while also viewing content such as a web page or content accessed through or by the Internet on the laptop 130. Content transmitted to the user 110 by, through, or from one electronic device, such as the laptop 130, may be based on, associated with, or related to content provided by a second electronic device, such as the television 120.

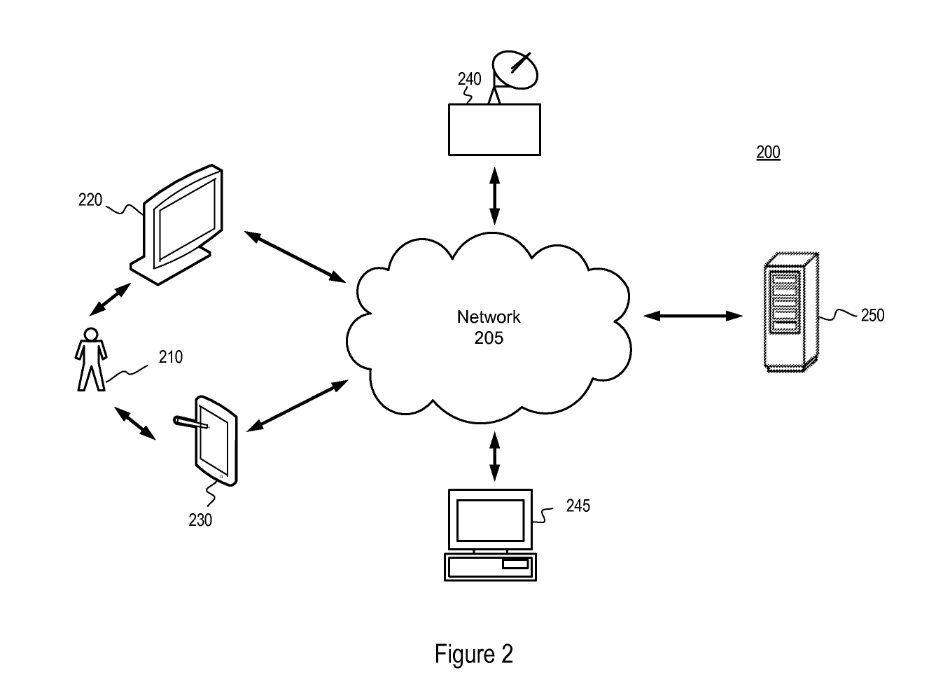

FIG. 2 is a diagram of a network environment 200 which may include two or more electronic devices 220 and 230, as well as a content system 250 for providing content on a first electronic device based on content playing on, transmitted by, or received from a second electronic device. The electronic devices 220 and 230 may provide content to the user, and may be the same as, similar to, or resemble the electronic devices 120 and 130 of the user environment 100. Alternatively, one or more of the electronic devices may be different, and/or may be or represent any other electronic device described. The network environment 200 may also or alternatively include one or more content sources 240 and 245.

Any one or more of the electronic devices 220 and 230, content sources 240 and 245, and content systems 250 may be interconnected or in communication with each other through one or more network 205. For example, the content sources 240 and 245 may be configured or operable to create, generate, gather, provide, and/or otherwise transmit content to one or more of the electronic devices 220 and 230 through or via the network 205. The network 205 may couple systems or devices so that communications may be exchanged, such as between a server and an electronic device or other types of devices, including between wireless devices coupled via a wireless network, for example. The network 205 may also include mass storage, such as network attached storage (NAS), a storage area network (SAN), or other forms of computer or machine readable media, for example. The network 205 may be or include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

Different content sources 240 and 245 may create, generate, gather, provide and/or otherwise transmit different content and different types of content to different electronic devices. For example, one or more content sources 240 such as a broadcast station, cable provider, or satellite provider may create, generate, gather, provide, and/or otherwise transmit various television content, such as television programs, broadcasts, or events, to a television 220 through or using the network 205. The televised content may be or include audio, video, image, text, or other data, signals, information and/or advertisements. The televised content may, in some instances, be associated or related to one or more television stations or television channels.

In some network environments 200, there may be multiple content sources 240. In some of these network environments 200, each content source 240 may be configured or operable to transmit information related to one or more television stations or channels. For example, one content source 240 may provide content for or related to one television station or television channel, while a second content source 240 may provide content for or related to a second television station or television channel. In other examples, one content source 240 may provide content for or related to multiple television stations. Other variations are possible.

Other content sources may provide other types of content, which may be transmitted to or broadcast by the same or different electronic devices 220 and 230. For example, content sources 245 may create, generate, gather, provide and/or otherwise online content and information to one or more electronic devices, such as a tablet 230, phone, computer, laptop 120 or various other electronic devices, through or using the network 205. The online content may be or include audio, video, image, text, or other data, signals, information, and/or advertisements, web pages or web sites, chat or social networking sites, online content or information, streaming audio or video information, and various other digital and electronic information receivable by a network or online enabled electronic device. Examples of content sources 245 may be or include web providers, online providers, online content providers, Internet or network providers, other users, businesses, entities, and various other sponsors configured or operable to provide web or online content, online shopping or advertising, social networking sites, or various other online experiences to a user.

In some network environments 200, there may be multiple content sources 245. For example, there may be various content sources 245 configured or operable to transmit information related to one or more web sites, social networks, or various other online content resources. For example, one content source 245 may provide content for or related to one web site or web page, while a second content source 240 may provide content for or related to a second web site or web page. In other examples, one content source 240 may provide content for or related to multiple web pages. Other variations are possible.

While the network environment 200 shows content source 240 which may provide televised content and content source 245 which may provide online content, many other content sources may exist and be included in the network environment. For example, content sources which may create, generate, gather, provide, and/or otherwise transmit electronic device-specific content may be included in the network environment 200. Some examples of other content sources that may be included in the network environment 200 may include contents sources which provide audio stores or sources that create, generate, gather, provide, and/or otherwise transmit audio content for use with a portable media device, smart-phone specific stores or sources that create, generate, gather, provide, and/or otherwise transmit phone content for use with a smart phone, textual stores or sources which may provide textual content for use with electronic readers or tablets, and/or various other content sources, any of which may provide content to one or more electronic devices through the network 200.

The electronic devices 220 and 230 may receive content from the one or more content sources 240 and 245, and may provide, display, or otherwise transmit the received content to the user 210.

For example, the television 220 may be configured or operable to receive the televised content from one or more of the content sources 240. In some systems, the television may be set, tuned, or otherwise programmed to receive televised content from only one or some of the content sources 240. For example, a user 210 may tune a television 220 to one television station, and the television 220 may then receive the televised content for or related to the tuned television station created or transmitted by the associated content source 240. In other systems, the television 220 may receive televised content for multiple television stations or channels created or transmitted by each of the associated content sources 240. The television 220 may broadcast, display, play, transmit, or otherwise provide content from one or more content sources 240. For example, the televised content for or related to the tuned television station or channel may be visually and audibly played or provided by the television 220 to the user 210.

As another example, the tablet 230 may be configured or operable to receive the online content from one or more of the content sources 245. In some systems, the user 210 may enter a content address, such as a uniform resource locator (“URL”) address, which may designate which a source or location of online content the user 210 wishes to view or be provided with by the tablet 230. In some systems, content located at the content address may be received by the tablet 230 from the content source 245 which may have created or transmitted the online content. In some systems, additional or other online content may be added to or provided with the requested online content. The tablet 230 may broadcast, display, or otherwise provide content from one or more content sources 245. For example, the online content for or related to the content address may be visually or audibly played or provided by the tablet 230 to the user 210. Various other examples and configurations are possible.

In addition or alternatively, one or more other electronic devices, such as a smart phone, a mobile phone, a cellular phone, a processor, a computer, a laptop, a server, a personal digital assistant (“PDA”), pager, network-enabled television or other television, digital video recorder, such as TIVO®, automobile, television, appliance or platform capable of data communications, a Global Positioning System (“GPS”) devices, gaming systems, or one or more other devices may receive content from one or more content sources 240 and 245 or other content sources. The one or more other electronic devices may provide the content from the content sources 240 and 245 to the user 210. Various other examples and configurations are possible.

One or more of the content sources 240 or 245 may be, include, and/or use a content server. A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also or alternatively host a variety of other sites, including, but not limited to business sites, educational sites, dictionary sites, encyclopedia sites, wikis, financial sites, government sites, etc. A content server may provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of devices that may operate as a content server include desktop computers, multiprocessor systems, microprocessor-type or programmable consumer electronics. Other examples are possible.

The content system 250 of the network environment 200 may be in communication with one or more of the electronic devices 220 and 230 and/or the content sources 240 and 245. The content system 250 may provide additional content or advertisements to the user 210 on various electronic devices without prompt from the user 210.

For example, one or more content sources 245 may be or include advertisers, businesses, or other entities. An advertiser may produce an advertisement, in the form of online content, which the advertiser may wish to provide or have displayed to a user 210 when the user views other content, such as television content, or during other advertisement opportunities (sometimes referred to as “advertising opportunities”). An advertisement opportunity may refer to an opportunity for an advertiser or content provider to provide an advertisement to one or more user device. Advertisements or other additional content may fill or otherwise be used during an advertisement opportunity. In some systems, a content system 250 may determine or set what may constitute an advertisement opportunity. For example, a content system 250 may prepare and conduct one or more auctions for the right to display an advertisement to a future user who fits one more specifications and operates one or more user devices. In this example, the content system 250 may dictate or determine what specifications the future user may need. In other examples, advertisement opportunities may be generated or created in other ways, such as whenever a user enters a search or seeks to view content from a content provider 245.

Advertisers with content which they may wish to deliver to a user may communicate with a central server, such as content system 250. The advertiser may generate an advertising campaign which may include or be associated with the advertisement. The advertising campaign may include one or more constraints or requirements for display of the advertisement. A constraint may include a keyword, phrase, or topic of television content that a user 210 may view that the advertiser would like to trigger a display of the advertisement. Various other constraints are possible.

The content system 250 may conduct an auction for advertisement opportunities to advertisers or advertising campaigns based on one or more possible constraints. For example, the content system 250 may conduct an auction for the opportunity to display an advertisement when an audio for a displayed television content includes a keyword, phrase, or topic. One or more advertisers may place a bid for the advertisement opportunity. The bid may indicate a cost or value that the advertiser may be willing or vouch to pay when the constraint or trigger element occurs (such as when an audio for a displayed television content includes the bid keyword, phrase, or topic). When the keyword, phrase, or topic occurs, the content system 250 may fill the advertisement opportunity with an advertisement of the advertising campaign associated with the highest (or winning) bid for the keyword, phrase, or topic.

In another example, the content system 250 may send or transmit a television program or advertisement to be displayed or presented to a user 210 on the television 220, without specific association with the channel the television 220 is tuned to. As another example, the content system 250 may transmit or send an article, webpage, or advertisement to be displayed or presented to a user 210 on the tablet 230, without specific association to the address that a browser may be on. In some instances, this additional content may be displayed before or after content that the user has specifically requested to tuned in for. In other instances, the additional content may be displayed simultaneously with requested content. The content system 250 may be configured to guide or provide content to one of the electronic devices, such as the tablet 230, based on what content is being provided to the user on or through another electronic device, such as the television 200.

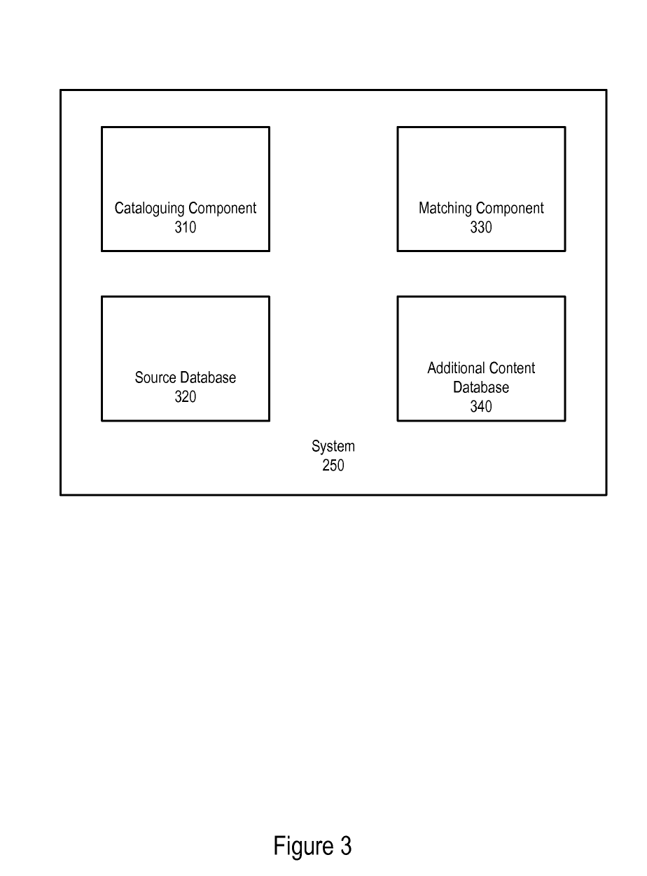

FIG. 3 is a block diagram of an example of a content system 250. The content system 250 may include one or more components and databases. For example, the content system 250 may include one or more of a cataloguing component 310, a source database 320, a matching component 330, and/or an additional content database 340. Various other components may be included in other content systems 250.

The cataloguing component 310 may be configured or operable to gather or otherwise receive content from one or more content sources, such as content source 240. In some systems, the cataloguing component 310 may receive some or all content available to a first electronic device from one or more content sources 240 or 245. For example, the cataloguing component 310 may receive all television programs, broadcasts, or events that are created, generated, gathered, provided and/or otherwise transmitted by each broadcast station, cable or satellite provider, or other content source 240 to the network 205 for possible reception and/or display by the television 220. As another example, the cataloguing component 310 may receive a portion or all online content created, generated, gathered, provided and/or otherwise transmitted by one or more content source 245 to the network 205 for possible reception and/or display by the tablet 230 or other online content device such as a laptop computer, PDA, phone, or network-enabled television. As another example, the cataloguing component 310 may receive all radio programs, broadcasts, or events, that are created, generated, gathered, provided, and/or otherwise transmitted by each radio content source to the network 205 for possible reception and/or display by a radio electronic device. Various other examples are possible.

In some systems, the cataloguing component 310 may gather some or all content from a selected number or set of content sources 240 and 245. The selected content sources 245 may be selected by a user, automatically programmed or set, or determined based on one or more algorithms or content of the content sources 245. For example, in some systems, the cataloguing component 310 may be configured or operable to gather all content from a select set of content sources 245 with trusted content which provide online content to a network 205, while ignoring or not gathering content from other content sources 245, such as content sources which are unverified or which may contain undesired content. Other variations are possible.

The cataloguing component 310 may gather or otherwise receive the content from content sources 240 and 245, regardless of whether any electronic device 220 or 230 is actually operating, turned on, tuned to, or otherwise providing or displaying the content to the user. The cataloguing component 310 may gather or otherwise receive the content continuously, at intervals, periodically, when triggered, or at various other times.

The cataloguing component 310 may store a portion or all of the gathered or received content in memory or one or more databases. For example, the cataloguing component 310 may store a portion or all of the content from each content source 240, and/or a representation of the content in the source database 320.

In some systems, the cataloguing component 310 may create, generate, gather, or otherwise obtain a representation of the content (sometimes referred to as a “content representation,” or “content fingerprint”). The content representation may be or include an identification characteristic of the content, such as a digital sample of the content, a unique portion of the content, a fingerprint of the content from the content source, and/or various other unique or identifiable characteristics, data, signals, or information of the content which may be compared with an unknown content. The cataloguing component 310 may store the content representation in a database or data store, such as the source database 320. In some systems, the cataloguing component 310 may store only the content representation, and not the content, in the source database 320. In other systems, the cataloguing component 310 may store only the content, or both the content and the content representation, in the source database 320.

The content and/or content representation may be used to identify a source of an unknown content which the content system 250 may receive. For example, an unknown content from a first electronic device may be compared with some or all stored contents or content representations. The unknown content may be determined to be a matching content or content associated with a matching representation of the content. Other variations and examples are possible.

The cataloguing component 310 may create, generate, gather, or otherwise obtain one or more content factors (also referred to as input data factors) related to or associated with the received content (or input data). Content factors may be or include data or information about the content, such as various traits, characteristics, and/or metadata which may describe the content. Some content factors may include a title or name of the content, a topic and/or category of the content, a description of the content, a transcript of the content, a date and/or time the content was created and/or broadcast by the content source 240, a creator of the content, elements or features within or described by the content, people or elements in or described by the content, and various metadata or other data about the content. The cataloguing component 310 may store the one or more content factors in a database or data store, such as the source database 320.

The content and/or content representations stored in the source database 320, may represent contents which are known to the content system 250. The stored content, content representation, and/or content factors may include or identify a source of the content and/or other known information about the content. The stored content, content representation, and/or content factors may be organized and searchable in the source database 320, such as by one or more of the factors or characteristics of the content, by the content representation, or by the content itself.

The content system 250 may also or alternatively include a matching component 330. The matching component 330 may be configured or operable to receive input data from one or more electronic devices. The input data may be or include, for example, one or more presently displayed unknown contents associated with an electronic device providing content to the user. The unknown content may be received, for example, from one or more electronic devices accessible to or providing content to the user 210. The electronic device transmitting or sending the unknown content to the content system 250, and/or the content system 250 itself, may not know some or any information about the unknown content received by the matching component 330.

The matching component 330 may be configured or operable to identify the content, a source of the content, and/or one or more factors or characteristics of the unknown content. For example, the matching component 330 may access one or more of the stored known contents, content representations, or content factors in the source database 320. The matching component 330 may compare the unknown content to the one or more stored known contents or content representations. In some examples, the matching component 330 may compare the unknown content with the stored and known contents. In other examples, the matching component 330 may create a content representation for the unknown content, and compare the content representation for the unknown content with the stored and known content representations. The matching component 330 may determine if any parts of the stored known contents or content representations are associated with, related to, match, or otherwise mimic part or all of the unknown content or a content representation of the unknown content. Where a portion or all of a stored content or content representations matches a portion or all of the unknown content or content representation of the unknown content being provided or displayed to the user, the matching component 330 may determine or identify the unknown content as being the stored content or content associated with the identified stored content representation.

As one example, the matching component 330 may compare a digital representation or fingerprint of the unknown content with each digital representation or fingerprint stored in the source database 320. The matching component 330 may determine, based on the comparisons, if any part of a stored digital representation or fingerprint matches the digital representation or fingerprint of the unknown content. Various other examples of comparison and determination techniques are possible. Where the fingerprint of the unknown content matches a content representation of a stored content, the matching component 330 of the content system 250 may know and identify the unknown content as the content associated with the matching content representation.

Once the unknown content is recognized or identified as a known matching content stored in the source database 320, the matching component 330 may identify, determine, or gather content factors associated with the previously unknown, presently displayed content (sometimes referred to as “recognized content”). The content factors of the matching content may be designated or otherwise identified as content factors of the recognized content (the unknown content that the matching component 330 received and identified). In this way, for example, the matching component 330 may identify a source of the unknown content and/or one or more content factors associated with the unknown content. Various other examples and variations are possible.

In some systems, the matching component 330 may also or alternatively be configured or operable to gather and/or receive information and data about the device transmitting the unknown content and/or a user 210 associated with the device sending the unknown content. For example, other input data received by the matching component 330 with the unknown content may include identification information about the transferring device, such as a type of device, a user of the device, a platform of the device, a registration or log-in information associated with the device, and various other device information. The matching component 330 may also or alternatively identify, determine, gather and/or receive data about the user 210, such as the location of the user 210, the age, race, and/or sex of the user 210, viewing habits of the user 210, and various other user attributes or information. In some examples, data about the user 210 may be gathered by identifying the device sending the unknown content, and determining or identifying information about the user owning or operating the sending device. In some systems, some or all information and data about the user 210 may be stored in one or more database that are part of the content system 250 or in communication with and accessible to the content system 250.

The matching component 330 may use, consult, compare with, or otherwise identify information in a database, such as an additional content database 340. The matching component 330 may determine whether or not to serve additional content in the additional content database 340 to one or more electronic device based on one or more characteristics or features of the recognized content.

In some systems, the additional content database 340 may store various types of additional content, such as various types of video, audio, image, or textual information or content. The additional content may be content which a content provider may wish to deliver or have provided to a user 210, such as advertisements, videos, sound clips, pictures or images, articles, informational or promotional materials, or various other contents. For example, the additional content database 340 may include articles, videos, images, manuals, advertisements, or various other information or marketing content that may be associated with content a user may view.

In some examples, the additional content database 340 may be or represent a campaign database, such as an advertising campaign database (sometimes referred to as an “advertisement database” or an “advertisement campaign database”). A campaign database may store information about one or more content campaigns created by and/or associated with one or more content providers. A content campaign may include, be associated with, and/or identify one or more sets of content (sometimes referred to as “campaign content”) which a content provider may wish to deliver or have provided to a user 210.

Campaign content associated with the content campaign, such as an advertisement associated with an advertising campaign, may be various types of video, audio, image, or textual information or content which a content provider may wish to deliver or have provided to a user 210, such as advertisements, videos, sound clips, pictures or images, articles, informational or promotional materials, or various other contents. Content providers associated with content campaigns may be or include various entities, such as other users, businesses, advertisers, content sources 240 or 245, and various other entities. A content campaign may be an advertisement campaign with advertisements which an advertiser may wish to deliver or have provided to a user 210. Various other examples are possible.

One or more of the additional content stored in the additional content database 340 (such as an advertisement stored in an advertising campaign database) may each include one or more specifications, requirements, or constraints. In a simplified example, one or more additional content may merely include a requirement that may be transmitted and displayed when a keyword or phrase appears or is broadcast in recognized content. In other systems, additional content specifications may identify content constraints, time constraints, user constraints, and/or display constraints regarding providing or displaying the additional content to the user. In the example where the additional content is associated with a content campaign, the restrictions may be referred to as campaign restrictions, and the additional content may be referred to as campaign content.

The additional content specifications and requirements may dictate, identify, restrict, or otherwise indicate when the additional content should be provided or displayed, and/or to whom or what device the additional content should be transmitted or sent to. The matching component 330 may compare gathered information about presently displayed content, users, electronic devices of a user, timing, and display opportunities with one or more of the specifications, requirements, or constraints to determine whether or not to serve additional content (or campaign content) to a user. The system 250 may additionally or alternatively conduct one or more auctions for advertising opportunities based on one or more specification, requirements, or constraints. While various constraints are discussed, in some instances, additional content may only be constrained by one or some constraints, or may not be constrained at all and may be displayed at any time.

Content constraints may relate to constraints on content being transmitted or displayed by an electronic device to a user (such as the recognized content received by the matching component 330) that the additional content should be displayed in proximity with or otherwise associated with. Content constraints may indicate a type of content, a specific content, a content category, keywords in a content, ideas in a content, a content description, or various other information about a content already provided to a user 210 which may be used to determine whether it is required, authorized, or allowable to send, transmit, or otherwise display campaign content associated with the content campaign to an electronic device or user 210. For example, the content constraints may identify or recognize favorable or preferable recognized content that is being provided or displayed to the user. In such circumstances, where the recognized content presently being viewed by a user 210 satisfies the content constraints, the matching component 330 may determine that it is required, or alternatively authorized, to provide or transmit the additional content to an electronic device of the user 210 in conjunction with the recognized favorable or preferable content. The content constraints may also or alternatively identify unfavorable content being displayed to or viewed by the user, and may be used to avoid providing the additional content in conjunction with the unfavorable content.

As an example, the matching component 330 may identify an unknown content it receives by comparing the unknown content to the content or content representations stored in the source database 320. Once identified, the matching component 330 may gather the content factors of the previously unknown and presently displayed content, and may compare these content factors with content constraints of one or more content campaigns. If the content factors of the presently viewed and previously unknown content fit with, match, or otherwise do not conflict with the content constraints, the matching component 330 may identify this as a favorable time to transmit the campaign content to an electronic device for display to the user. If instead the content factors associated with previously unknown and presently viewed content do not fit with, satisfy, or match content constraints, or otherwise conflict with the content constraints, the matching component 330 may identify or determine this as an unfavorable time to transmit the campaign content to an electronic device for display to the user. The content system 250 may thus prevent the campaign content associated with the content campaign from being provided or transmitted to an electronic device of the user 210. Other variations or examples are possible.

Time constraints may indicate a time period or time frame within which additional content may or may not be provided or displayed to a user 210. The matching component 330 may identify or gather a time associated with a device used by the user 210, an interaction of the user 210, or content displayed to the user 210. For example, the matching component 330 may identify a time that an unknown content is received by the matching component, or a time associated with the unknown content. The time of the unknown content may be compared with a time constraint to determine if the additional content may or may not be displayed to the user. As a specific example, the matching component 330 may receive an indication that a user 210 is viewing a content at 9:45 AM Eastern Standard Time on March 10. The time constraints may indicate that a campaign content associated with a content campaign may only be provided or displayed to a user between 8:00 AM Eastern Standard Time and 10:00 AM Eastern Standard Time every day in the month of March. In this example, the time constraint may indicate that the campaign content associated with the content campaign may be provided to the user. In other examples, the time constraints may be negatives, optional, or otherwise vary. Various other examples are possible.

User constraints may indicate a type of user, a specific user, a user category or attribute, a user description, or various other information about a user 210 which may be used to determine whether additional content may or should be provided or displayed. The user constraints may identify favorable or preferable users to whom the additional content may be displayed or provided, and/or may identify unfavorable users to whom the campaign content may not be displayed or provided. The matching component 330 may identify information about a user viewing a content, such as a user associated with unknown content received by the matching component 330. The matching component 330 may compare the information about the user to the user constraints of one or more additional contents. The matching component 330 may determine whether or not to provide the user with the additional content based on the comparison. If the gathered user information fit with, match, or otherwise does not conflict with the user constraints, the additional content may be provided or displayed to an electronic device of the user 210. If not, the additional content may not be provided to an electronic device of the user 210. For example, the matching component 330 may receive an indication that a user 210 is a male from California between the ages of 30 and 34. Where a user constraint indicates that some campaign content may only be provided to males between the ages of 20 and 49 in California, the user information may match, satisfy, or otherwise fit within the user constraints. In this case, the matching component 330 may be allowed or required to present the campaign content to an electronic device of the user. Display constraints may indicate display device information or data, content opportunity information, and various other display information or data which may be used to determine whether content associated with the content campaign should be provided or displayed to the user 210. Display constraints may be compared with information received about a display opportunity. If the display opportunity satisfies the display constraints the content may be provided or displayed to the user. Display constraints may also indicate where or when additional content should be displayed, once a display opportunity has been identified. For example, the content system 250 may be configured or operable to deliver or display additional content before, during, or after recognized content being played, displayed, or transmitted to a user through one or more electronic devices. For example, a content campaign may be configured or operable to provide the campaign content simultaneously with other recognized content being provided to a user, such as where the campaign content is an advertisement to be displayed on only a portion of a display while other recognized content is displayed at other portions of the screen. Other variations are possible.

In some instances, the matching component 330 may be configured or operable to provide additional content to an electronic device only when all of the constraints for the additional content are satisfied. For example, if content constraints, time constraints, and display constraints are satisfied, but a user constraint is not satisfied, that particular additional content may not be provided or displayed to an electronic device of the user. In other instances, when one, some, or a majority of constraints are satisfied, the additional content may be provided or displayed to the user. Each piece of additional content may be configured or set with circumstances or designations about what constraints may, should, or must be satisfied before the additional content may or should be displayed.

In some instances, the matching component 330 may merely be authorized to provide, transmit, or otherwise present campaign content when enough of the constraints are satisfied. In other instances, the matching component 330 may be required to provide, transmit, or otherwise present campaign content when enough of the constraints are satisfied. Where the matching component 330 determines that enough of the constraints are satisfied, the matching component 330 may determine that it is authorized or required to send the additional content to an electronic device of the user 210. Other variations and constraints are possible.

The content system 250 may determine whether a user is operating or receiving content from more than one electronic device at the same time. Data about related devices may be stored with the content system 250 or at a remote location. Examples of related devices may include devices owned, operated, registered, or associated with a log-in account or IP address for the same user 210, family of users, or people in a given location. Other examples of related devices may include any device that is registered together or designated as related to the first device, any device being operated in a geographic area near or with the first device any device that is operating on a same network, or various other related devices.

The content system 250 may identify a user 210 or device based on content received. The content system 250 may then determine whether the user 210 has other electronic devices that are related to it, such as by consulting the data about related devices. Where no other device is related to the device that sent the unknown data to the content system 250, the matching component 330 may generally deliver the campaign content to the one operating, registered, or logged-in electronic device. Where other related devices are identified, such as where the user 210 may be operating both the television 220 and the tablet 230 at the same time, the content system 250 may identify one, some, each, or all of the related devices, and may provide additional content to any of the identified electronic devices based on the recognized content. Various other methods of identifying devices and transmitting the campaign content are possible.

The content system 250 may conduct or hold one or more auctions to display additional content, such as advertisements, based on one or more specifications, requirements, or constraints. The system 250 may identify or determine one or more possible advertising opportunities (sometimes referred to as “advertisement opportunities”) that may arise to provide an advertisement to a user on a second device based on content displayed to the user on a first device. The system 250 may create and run an auction for the advertising opportunity based on one or more determined characteristics of the possible advertising opportunity. The additional content database 340 may be an advertising campaign database and may include a set of advertising campaigns and advertisements for advertisers or content providers. Advertisers or content providers who may be interested in displaying their advertisements for a possible advertising opportunity may bid in the auction for the right to display their advertisements if and when the possible advertising opportunity arises. When the possible advertising opportunity occurs, the system 250 may select the advertiser or advertising campaign with the winning bid for that auction, and may display the advertisement for that advertiser to the user 210 on the second device.

As one non-limiting example, the system 250 may generate a set of auctions, each auction based on a different keyword, such as a first auction for the keyword “baseball,” a second auction for the keyword “automobile,” and a third auction for the keyword “newspaper.” Advertisers may create and store advertising campaigns in or with the additional content database 340. A first advertiser, such as a car manufacturer, may desire to show an advertisement for a car product to a user 210 through an online device such as a tablet or smart phone whenever the word “automobile” is displayed or broadcast to the same user 210 on a television device. A second advertiser, such as a car dealership, may also desire to show an advertisement to the user 210 through an online device whenever the word “automobile” is displayed or broadcast to the user 210 on the television device. The first and second advertisers may each place or submit a bid to or with the system 250. The system 250 may monitor the content displayed to the user 210, and when the word “automobile” is displayed or broadcast, the system 250 may determine a winning bid for the keyword auction. If, for example, the first advertiser had a higher bid, the system 250 may gather the car product advertisement for the first advertiser and may transmit the advertisement to the second device for display to the user 210.

Auctions may be conducted for advertising opportunities that may be associated with any requirements or specifications. As an example, the content system 250 may conduct an auction or solicit bids for an advertising opportunity that may be associated with a content factor, such as a keyword, phrase, or topic of content. Advertisers or other content provides 245 may submit bids to the content system 250 for the opportunity to have an advertisement displayed if or when the advertising opportunity occurs. Once content displayed to a user on a first device is identified, the matching component 330 may gather the content factors of the displayed content, and may determine a type of advertising opportunity that may exist. For example, where the content factors indicate a type of content that matches the type of content for the advertising opportunity, the matching component 330 may determine an advertiser with a winning bid for the auction for the advertising opportunity. The system 250 may then transmit the advertisement associated with the winning bidder to the second device for display with or during the advertising opportunity.

The content system 250 may conduct an auction or solicit bids for an advertising opportunity that may include or be specified or restricted by a time constraint. For example, an auction may be conducted for advertisement opportunities that may arise during a specific time period. Advertisers may place bids for opportunities arising during the specific time period. The matching component 330 may determine an advertiser with a winning bid for the auction for an advertising opportunity arising during the specific time period.

The content system 250 may conduct an auction or solicit bids for an advertising opportunity that may include or be governed by a user constraint. The system 250 may conduct an auction for advertisement opportunities specific to a type of user. As one example, the auction may be conducted for an advertisement opportunity for a male between the ages of 20 and 30. Advertisers may place bids for these advertisement opportunities specified by the auction. When an advertisement opportunity arises fitting the user constraints of the auction (such as an advertisement opportunity for a male between the ages of 20 and 30), the content system 250 may determine the winning bidder and may serve an advertisement for the winning bidder to the user to fill the advertisement opportunity.

In some auctions, an advertiser or content provider may solicit a bid in an auction that the advertiser or content provider may limit based on a constraint or specification not required by the auction. For example, an advertiser may place a bid for an advertisement opportunity indicating that the bid is valid only for a specific period of time or for a specific time window, regardless of whether the auction set up by the system 250 specifies a specific time period for the auction or advertisement opportunity. In these situations, when the advertisement opportunity arises, the system 250 may choose the highest bid with a specified time range that includes the time when the advertisement opportunity arises. As one example, an advertiser may place a bid for an advertisement opportunity associated with a keyword “car,” and may specify that the bid is only valid when the advertisement opportunity arises between March 1 and March 15. If the advertisement opportunity associated with the keyword “car” arises during the specified time window (such as between March 1 and March 15), the bid of the advertiser may be considered by the content system 250 in determining a winning bidder. If the advertisement opportunity does not arise within the specified time window, the advertiser's bid may be ignored.

As another example, an advertiser may place a bid for an advertisement opportunity, specifying that the bid is valid only for a specific user type or constraint, regardless of whether the auction set up by the system 250 specifies a user constraint. As one example, the advertiser may bid for an auction for the keyword “baseball,” and may specify that their bid only applies to advertising opportunities for males between the ages of 20 and 30. In this example, when the advertisement opportunity arises for a different user type, such as a female over 40 years of age, the system 250 may ignore the advertiser's bid. If instead the advertisement opportunity for the keyword “baseball” arises for a male age 25 years, the system 250 may consider the advertiser's bid in determining the winning bid for the advertising opportunity.

Auctions may be conducted for advertisement opportunities based on more than one constraint or specification. For example, an auction may be conducted for an advertisement opportunity that may arise for a user who is male between the ages of 20 and 30, occurring between March 1 and March 15, where the user is viewing content with the phrase “Green Bay Packers.” Advertisers may bid on the advertising opportunity, with the content system 250 selecting a winning bidder and transmitting an advertisement when the advertising opportunity arises. Other auction and bidding variations are possible.

The content system 250 in FIG. 3 is described as including a cataloguing component 310, a source database 320, a matching component 330, and an additional content database 340. In other variations, one or more additional components may be included with the content system 250, and/or one or more components may be removed or combined. For example, in some systems, the source database 320 and the additional content database 340 may be combined. In other systems, one or more of the cataloguing component 310, a source database 320, a matching component 330, and an additional content database 340 may be composed of multiple separate components. For example, the matching component 330 may include separate components for performing one or more of the tasks of receiving an input data or content, matching the content with content in the source database 320, identifying or determining additional content to server to an electronic device, and/or transferring the additional content to an electronic device. Various other variations and examples are possible.

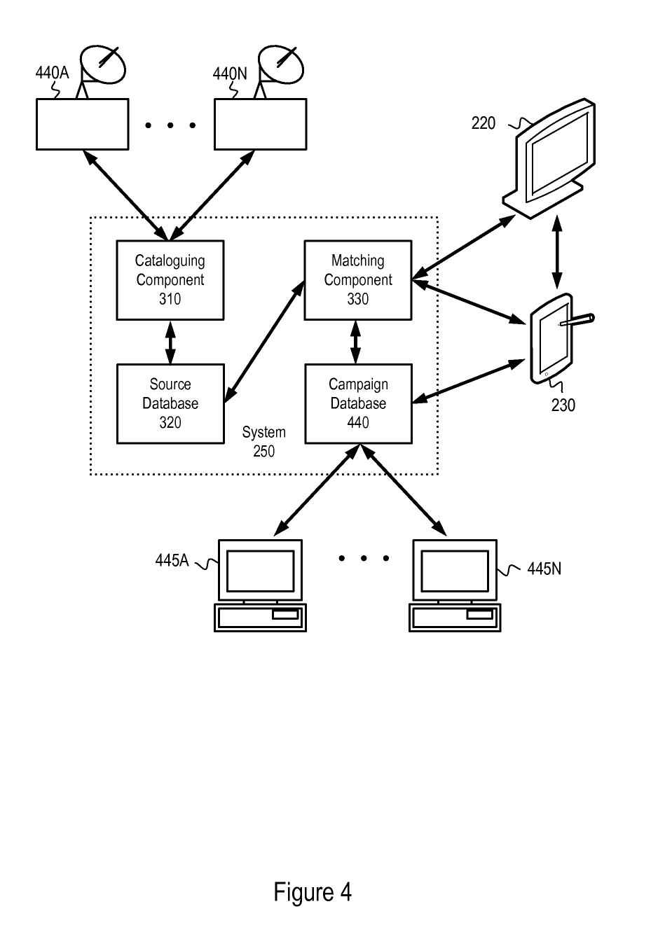

FIG. 4 shows an example of how the content system 250 may provide additional content to an electronic device 230 based on content being provided or displayed to the user on an electronic device 220.

Prior to or simultaneously with the receipt of an unknown content, the cataloguing component 310 may receive content from one or more content sources 440A-440N. The content received from one or more content sources 440A-440N may represent content that may be available to a first user electronic device. As an example, the cataloguing component 310 may receive all television broadcasts that would be available to a television 220 of a user 210. The cataloguing component 310 may store the content, a representation of the content, and content factors for some or all of the content received in the source database 320.

Prior to or simultaneously with the receipt of an unknown content, one or more content sources 445A-445N or other campaign providers may create or generate one or more content campaigns in the campaign database 440. For example, one or more advertisers may create one or more advertisement campaigns in the campaign database 440, with various campaign constraints and content associated with the campaigns. While the system in FIG. 4 shows a campaign database 440, it should be appreciated that in other variations, the campaign database 440 may be replaced by the additional content database 340 or various other databases, and/or the campaign content may be replaced by other additional content.

At some point, the matching component 330 may receive an unknown content associated with a first electronic device 220. The unknown content may, in some instances, be received by the first electronic device 220 itself. For example, the television 220 may gather or receive data, signals, or information about the content that it will display, or may include a microphone, camera, or other recording device which may record the content displayed by the television 220. The television 220 may send the unknown content to the matching component 330 directly.

In other systems, the unknown content may be received by a second electronic device, such as the tablet 230. For example, the tablet 230 may record an audio or video signal or various images, which is may transmit to the matching component 330. The recorded audio or video signal or various images may, for example, be an audio or video signal or various images from the television 220, which the tablet 230 may have gathered or recorded with or using a microphone, camera, or other recording device.

In still other systems, a third electronic device may gather and transmit the unknown content, or the unknown content may be gathered and or accessed by the matching component 330 in various other ways. Other electronic devices, such as smart phones, laptops, or set-top boxes, may gather unknown data, signals, or information in various other ways. In other systems, various other examples of unknown data, signals, and information are possible, and may be gathered or received in various other ways.

In some systems, in addition to the unknown content, the matching component 330 may receive, determine, gather, or otherwise identify information about the time/date that the unknown content was received, and/or a user associated with content (such as a user associated with the first electronic device providing the unknown content or an electronic device transmitting the unknown content).

The matching component 330 may compare the unknown content from the first electronic device 220 (or a content representation of the unknown content) to the content (or content representations) stored in the source database 320. When a matching content for the unknown content is found, the matching component 330 of the content system 250 may determine that the unknown content being provided to the user by electronic device 220 is the matching content. The matching component 330 may identify, gather, or otherwise collect content factors of the matching content, and may associate or attribute these content factors to the recognized content that was received by the matching component 330.

The matching component 330 may compare the recognized content and content factors with constraints for the additional content, such as with campaign constraints of one or more content campaigns. Based on the comparison, the matching component 330 may determine or identify a campaign from the campaign database 440 with campaign constraints that the identified content, time information, and/or user information may satisfy, and may identify an additional content associated with the identified campaign to be transmitted for display to the user. In some systems, the matching component 330 may conduct an auction for a right or opportunity to transmit an advertisement or additional content to the user viewing the identified content on the device 220. The auction may be conducted in advance of, at the same time as, or after identifying the content. One or more advertisers or content providers, such as advertisers with advertising campaigns stored or associated with the campaign database 440, may bid in the auction. The matching component 330 or another component of the system 250 may determine the winning bidder of the auction. The additional content in this example may be an advertisement associated with the winning advertising campaign or advertiser.

The matching component 330 may also identify the device from which the recognized content originated (such as the television 220), or the device that transmitted or sent the recognized content to the content system 250 (such as the tablet 230). The matching component 330 may identify or determine one or more electronic devices associated with the user 210 that received the recognized content. In some instances, the matching component 330 may determine, select, or identify an electronic device that may be different from the electronic device from which the recognized content originated from.

The campaign database 440 may send or transmit the campaign content, or winning advertisement, directly to one or more electronic devices, or the matching component 330 may gather the campaign content associated with the satisfied campaign or winning advertisement associated with the winning bid from the campaign database 440 and may provide the campaign content or winning advertisement to an electronic device associated with the user 210.

In some instances, the content system 250 may provide the campaign content or winning advertisement to an electronic device different from the electronic device that the unknown content originated from or was transmitted or displayed to the user 210. In this way, the content system 250 may provide advertisements or other additional content to a user on a second electronic device which may be relevant or related to content being provided at the same or a similar time to the user via a first electronic device. While the system in FIG. 4 is described as delivering campaign content or advertisements, in other variations, the system may deliver other additional content.

In some instances, the content campaigns may be advertisement campaigns set up with, through, or by one or more content providers. Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements as additional content on a second or other electronic device. Bids may be associated with amounts advertisers pay for certain specified occurrences, such as for placed or clicked-on advertisements as additional content on one or more electronic device. Advertiser payment for publishers or publisher networks, one or more marketplace facilitators or providers, or potentially among other parties. Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example, In various models, advertisers may pay based at least in part on any of various metrics associated with advertisement delivery or performance, or associated with measurement or approximation of particular advertiser goal(s). For example, models may include, among other things, payment based at least in part on cost per action for some specified action(s), cost per conversion or purchase, or cost based at least in part on some combination of metrics, which may include online or offline metrics, for example. Other variations are possible.

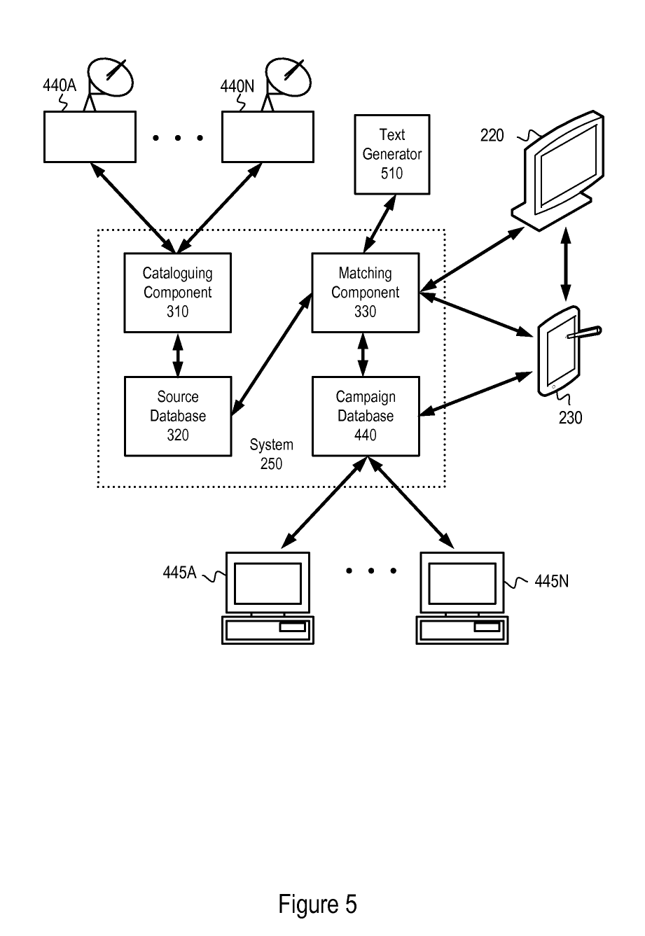

FIG. 5 shows another example of how the content system 250 may provide campaign content or winning advertisements to an electronic device 230 based on content being provided or displayed to the user on an electronic device 220. The content system 250 may operate in a similar manner as in FIG. 4. However, the system in FIG. 5 may also include a text generator 510. Though the text generator 510 is shown in FIG. 5 as being separate from the content system 250, in other variations and systems, the text generator may be included in or part of the content system 250.

The text generator 510 may be configured, operable, or used to generate text information, a transcript, or closed-captioning information for one or more video or audio content. For example, prior to or simultaneously with the receipt of an unknown content, the cataloguing component 310 may receive video or audio content from one or more content sources 440A-440N. The video or audio content received from one or more content sources 440A-440N may represent content that may be available to a first user electronic device, such as to a television 220.

The text generator 510 may generate text information, a transcript, or closed-captioning information about the video or audio content from the one or more content sources 440A-440N. The text information, transcript, or closed-captioning information may be a content representation and/or a content factor. The cataloguing component 310 may store the content, content representation, and/or content factors for some or all of the content received in the source database 320.

In some systems, when an unknown content is received by the matching component 330, the unknown content may be fed to the text generator 510, which may generate text information, a transcript, or closed-captioning information about the unknown content. In some of these systems, the text information, transcript, or closed-captioning information may be compared to the text information, transcripts, or closed-captioning information from the video or audio content from the one or more content sources 440A-440N. In this example, the text information, transcripts, or closed-captioning information may be or perform the functions of content representations, such that the unknown content may be determined or identified by finding or determining a content associated with text information, transcripts, or closed-captioning information that matches a portion or all of the text information, transcript, or closed-captioning information of the unknown content.

In other systems, the text information, transcript, and closed-captioning information may be or represent content factors, but may not be used to identify unknown content itself. In some such systems, unknown content may be identified in various other ways discussed herein, such as using digital fingerprints or other methods. In some of these systems, however, once the unknown content is identified, the text information, transcript, or closed-captioning information associated with the content that matches the unknown content may be attributed to the unknown content. In this way, a transcription of the video or audio unknown content may become known. In these examples, the matching component 330 may use the textual information, transcript, or closed-captioning information about the unknown content to compare with campaign constraints and determine whether or not to serve additional campaign content to a user.

As a specific example, a content campaign may indicate that the content system 250 should display the campaign content whenever the word “pizza” is said, unless the word “hate” is mentioned within 3 words of “pizza.” In this instance, the matching component 330 may first identify an unknown content using various methods, such as matching digital representations or other content representations with those stored in the source database 320. Once the content is identified, the matching component 330 may gather a transcript of the content, which may be stored as a content factor in the source database 320. The matching component 330 may analyze the transcript and may determine if the word “pizza” appears in the transcript. If “pizza” does not appear, then the content constraint is not satisfied, and the campaign content associated with it is not shown or provided. If “pizza” does appear, then the matching component 330 may search the surrounding words of the transcript for the word “hate.” If “hate” appears, then the content constraint is not satisfied, and the campaign content associated with it is not shown or provided. If “hate” does not appear, the content constraint is satisfied. If all or enough other constraints are also satisfied, the campaign content may be provided to an electronic device of the user. In some systems, the campaign content is provided for display when the desired word “pizza” is mentioned in the unknown content, or otherwise around or contemporaneously with when the word “pizza” is mentioned. Many different algorithms, stipulations, and constraints may be implemented using textual information, transcripts, or closed-captioning information in associated with content constraints. Various other examples are possible.

The system in FIG. 5 is shown with a campaign database 440. In other variations of the system, the campaign database 440 may be replaced by an additional content database 340 or various other databases. In some instances, the databases may be located remotely and accessed via one or more networks.

Systems, such as the system 250 in any of FIGS. 3-5, may be used to provide advertisements or additional content to the user. In some instances, the additional content may be provided to the same device that the user is viewing other content on. For example, content viewed on a television 220 may be provided to the content system 250, and an advertisement or additional content may be selected based on an auction and/or the television content, such as with or using the text generator 510 or other components of the content system 250, and may be provided back to the television 220. In other systems, the additional content may be provided to a different electronic device, such as the tablet 230. Other variations are possible.

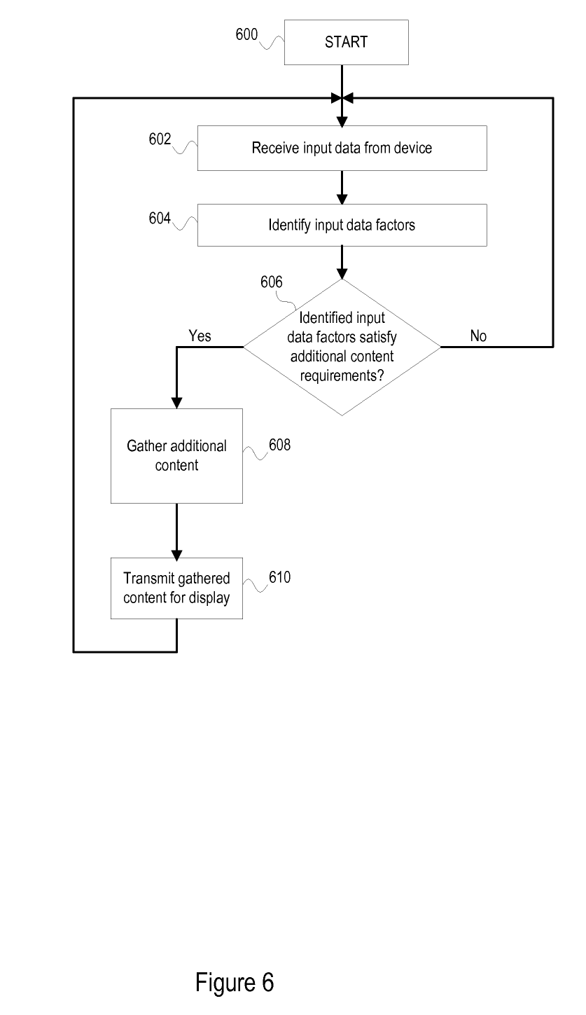

FIG. 6 is an example method of providing content with a content system 250. The method of FIG. 6 may be performed, for example, by the matching component 330 to determine and/or gather additional content to be transmitted or sent to an electronic device. The method may begin at block 600.

At block 602, input data may be received from a device. The input data may be or include one or more unknown contents. For example, an electronic device such as a television 220 may transmit or send unknown content and/or other input data to the matching component 330 of the content system 250. In some examples, the input data may also or alternatively include user data, content data, time data, device data, or various other data.

At block 604, content factors or other input data factors may be identified. For example, the matching component 330 may determine what the input data or received content is or represents, such as by comparing the input data or content (or an input data representation or content representation) with content stored in the source database 320. Once the input data is identified, the matching component 330 may identify, determine, gather, or otherwise obtain input data factors or content factors for the identified content from the source database 320. Such input data factors may include, for example, data or information about the input data, such as various traits, characteristics, and/or metadata which may describe the input data or content. Some input data factors may include a title or name of the input data or content, a topic and/or category of the input data or content, a description of the input data or content, a transcript of the input data or content, a date and/or time the input data or content was created and/or broadcast, a creator of the input data or content, elements or features within or described by the input data or content, people or elements in or described by the input data or content, and various metadata or other data about the input data or content.

At block 606, the matching component 330 may compare the identified input data factors to constraints associated with one or more additional contents. For example, the matching component 330 may compare the identified input data factors to campaign constraints associated with one or more content campaigns. The matching component 330 may determine, based on the comparison, whether or not the input data factors satisfy or match requirements for additional content. In some systems, additional content requirements or specifications (or content campaigns) may specify that all constraints (or campaign constraints) must be satisfied before an additional content requirements (or content campaigns) are considered to satisfy or match the input data factors. In other systems, the addition content requirements may only require that one or some constraints be satisfied before the additional content requirements are considered matched with the input data factors. Other variations are possible.

If the input data factors do not satisfy or match additional content requirements of an additional content, the method returns to block 602 and awaits the next receipt of input data at the matching component 330. In this case, the matching component 330 may not have found any additional content in the additional content database 340 that may be related to or desirable to display contemporaneously with the input data.

If instead the identified input data factors match or satisfy the additional content requirements, the method may proceed to block 608. At block 608, the additional content associated with the matching content campaign may be gathered. In some instances, the matching component 330 may gather the additional content from the additional content database 340. In other systems, the additional content database 340 may instead identify the additional content.

At block 610, the gathered content may be transmitted to one or more electronic devices of the user 210 for display. After block 610, the method may return to block 602 and await the next receipt of input data by the content system 250.

The method of FIG. 6 may also be applied to determine whether or not a winning bid or content associated with a winning bid of an auction being conducted by a content system 250 may be delivered or transmitted in response to receiving input data. At blocks 602 and 604, input data may be received, and data factors about the input data may be identified. At block 606, the identified input data factors may be compared with the requirements or constraints of the auction. If the identified input data factors do not satisfy or match the requirements or constraints of the auction, the auction may not select a winning bidder, and method may return to block 602. If the identified data factors do satisfy or match the requirements or constraints, the method may move to block 608.

For example, an auction may be conducted for an advertisement opportunity that may be associated with a user who is a male between the ages of 20 and 30, living in Alaska, and viewing content about the “Green Bay Packers.” If the input data factors indicate that the input data is being viewed by a user that does not fit one or more of the criteria of the auction, the auction may not determine a winning bidder or may not be used to determine an additional content or advertisement to be displayed to the user. If instead the input data factors match or satisfy the requirements of the auction, the method may proceed to block 608.

At block 608, the auction may select a winning bidder based on bids that have been submitted by one or more advertisers. When the winning bidder is determined, the content system 250 may gather an advertisement associated with the winning bidder at block 608. At block 610, the advertisements associated with the winning bidder may be transmitted to a user device. Other variations are possible.

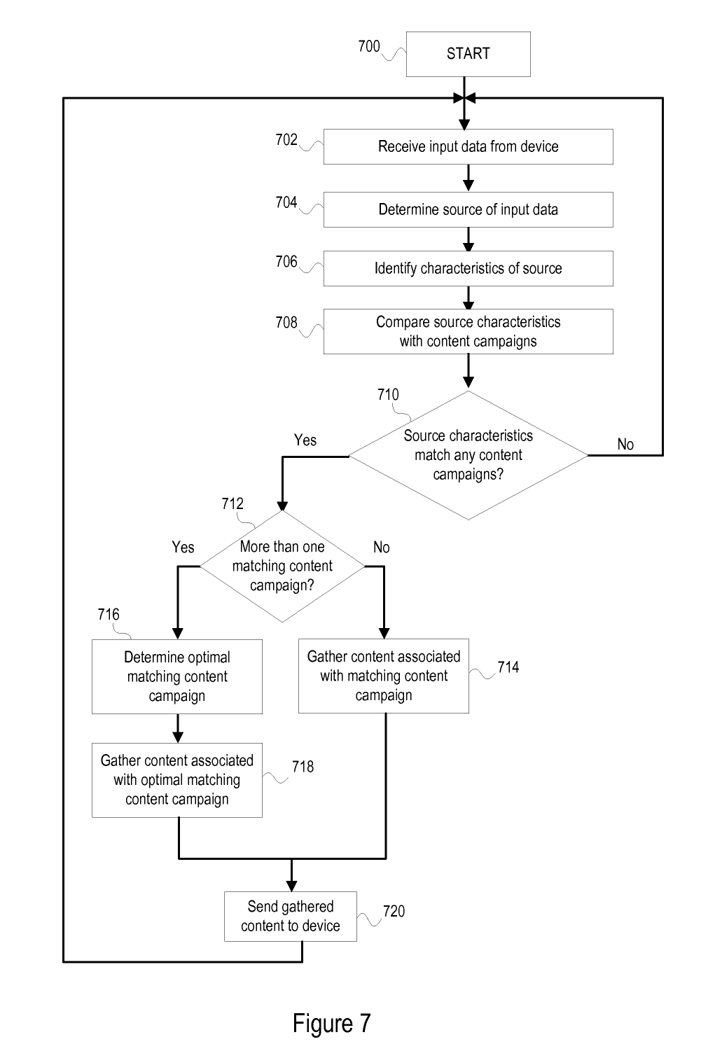

FIG. 7 is another example method of providing content with a content system 250. The method in FIG. 7 may be described with reference to the specific example of campaign databases 440 and campaign content, but it should be appreciated that this method may be applied to systems with an additional content database 340 and additional content requirements.

The method may begin at block 700. At block 702, input data may be received from a device. The input data may be or include one or more unknown contents. For example, an electronic device such as a television 220 may transmit or send unknown content and/or other input data to the matching component 330 of the content system 250. In some examples, the input data may also or alternatively include user data, content data, time data, device data, or various other data. Block 702 may be similar or the same as block 602 in the method of FIG. 6.

At block 704, a source, or identity, of the input data may be determined. For example, the matching component 330 may determine what the input data or received content is or represents, such as by comparing the input data or content (or an input data representation or content representation) with content stored in the source database 320. This may be performed, for example, by or through a comparison of a digital representation or fingerprint of the received input data with a database or set of digital representations or fingerprints of known data or contents. When a known data or content is matched with the received input data, the matching component 330 may determine that the known data or content is the source of the input data.

At block 706, the matching component 330 may identify characteristics of the source (or matching known data or content). The characteristics may, for example, be content factors. For example, once the source is identified, the matching component 330 may identify, determine, gather, or otherwise obtain characteristics for the identified source content from the source database 320. Source characteristics may include, for example, data or information about the source content, such as various traits, characteristics, metadata which may describe the source content, a title or name of the source content, a topic and/or category of the source content, a description of the source content, a transcript of the source content, a date and/or time the source content was created and/or broadcast, a creator of the source content, elements or features within or described by the source content, people or elements in or described by the source content, and various metadata or other data about the source content.

At block 708, the matching component 330 may compare the source characteristics to one or more campaign constraints associated with one or more content campaigns. The matching component 330 may determine, based on the comparison, whether or not any of the content campaigns satisfy or match the source content characteristics. In some systems, the content campaigns may specify that all campaign constraints must be satisfied before a content campaign is considered to satisfy or match the source content characteristics. In other systems, the content campaign may only require that one or some campaign constraints be satisfied before the content campaign is considered satisfied or matched with the source characteristics. Other variations are possible.

At block 710, the matching component 330 may determine whether the source characteristics satisfy or match any of the content campaigns. If the source characteristics do not satisfy or match a content campaign, the method returns to block 702 and awaits the next receipt of input data at the matching component 330. In this case, the matching component 330 may not have found any additional content in the campaign database 440 that may be related to or desirable to display contemporaneously with the input data.

If instead a content campaign matches the identified input data factors, the method may proceed to block 712. At block 712, the method may determine whether or not more than one content campaign matches the source characteristics.

Where only one content campaign matches the source characteristics, the method may proceed to block 714. At block 714, campaign content associated with the matching content campaign may be gathered. In some instances, the matching component 330 may gather the campaign content from the campaign database 440. In other systems, the campaign database 440 may instead identify the campaign content.

At block 720, the gathered content may be transmitted to one or more electronic devices of the user 210 for display. After block 720, the method may return to block 702 and await the next receipt of input data by the content system 250.

Returning to block 712, if instead more than one content campaign is satisfied or matches the source characteristics, the method moves to block 716. At block 716, the optimal content campaign, from the matching content campaigns, is determined. The matching component 330 may perform one or more algorithms or make one or more determinations about which content campaign represents the optimal matching content campaign. For example, the matching component 330 may select the content campaign based on one or more factors or combination of factors, such as the content campaign with the most relevance to the user, the most matching constraints, the highest bid or other value, the campaign used the most recently, the campaign used the longest ago, the content campaign with the most historic success or value, randomly, or in various other manners.

Once the optimal matching campaign is determined or selected, the method may proceed to block 718, where the content associated with the optimal matching content campaign may be gathered. The gathering in block 718 may be similar or the same as the gathering in block 714. At block 720, the gathered content may be transmitted to one or more electronic devices of the user 210 for display. After block 720, the method may return to block 702 and await the next receipt of input data by the content system 250.

In some alternative methods, once a matching content campaign is identified, the matching component 330 may stop all searching for matching content campaigns. As such, the method may skip block 712 and proceed directly from block 710 to block 714. In some of these systems, the order that the content campaigns may be searched or compared with the identified input data factors may be pre-arranged based on one or more criteria, such as pre-arranged based on an auction bid for placement of the campaign content, geography, relevance to the user, or various other factors. Other variations and methods are possible.

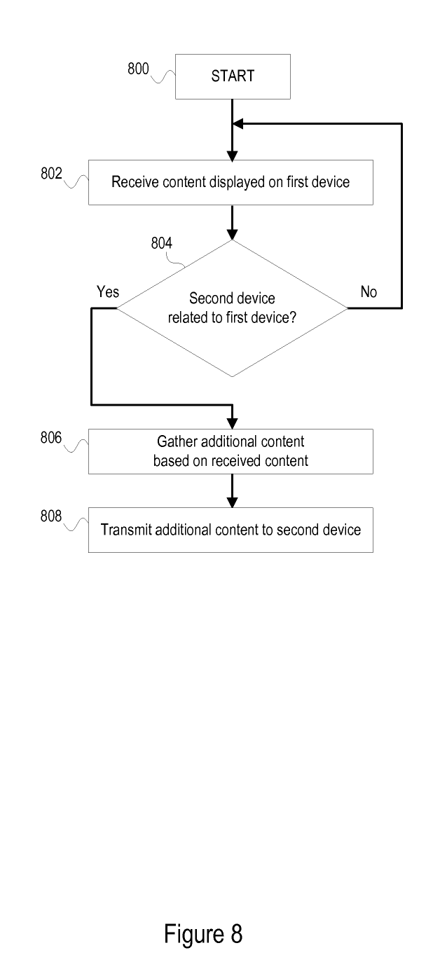

FIG. 8 shows a method of providing content. The method begins at block 800. At block 802, content that is displayed, played, transmitted on, or otherwise shown or broadcast on a first device is received by the content system 250. For example, the matching component 330 may receive content broadcast on a television station on the television 220. The content may be received on or by the television 220 itself, or one or more other electronic devices, such as a tablet 230 or another microphone or device. In some other systems, the content system 250 may monitor the content being broadcast, played, displayed, or otherwise transmitted from the first electronic device, and/or may actively gather the content from the first electronic device.

At block 804, the matching component 330 may determine whether a second device related to the first device is turned on, is registered, is operating, or otherwise exists. Examples of related devices may include devices owned, operated, registered, or associated with a log-in account or IP address for the same user 210, family of users, or people in a given location. Other examples of related devices may include any device that is registered together or designated as related to the first device, any device being operated in a geographic area near or with the first device any device that is operating on a same network, or various other related devices.

If no second device is related to the first device, the method may return to block 802. If instead a second device is related to the first device, the content system 250 may gather additional content or advertisement based on the received content. For example, the content system 250 may identify and gather an advertisement associated with a winning bid in an auction for the right to display or transmit an advertisement to the second device of the user. As another example, the additional content may be related to a content, topic, idea, actor, title, keyword, phrase, image, or various other aspect or characteristic of the content displayed on the first device. The additional content may be supplemental content to the received content, such as a story about something shown, described, or mentioned in the first content. The additional content may be an advertisement for a product shown, described, or mentioned in the first content. The additional content may be various other contents which may be associated with, related to, based on, or otherwise linked to the content displayed on the first device. In some systems, the additional content may be gathered by the matching component 330 in various ways, such as by or using the methods of FIGS. 6 and 7 or other methods discussed.

At block 808, the gathered additional content may be transmitted to the second device. The second device may then display, play, or otherwise broadcast the additional content.

As an example, a user 110 may sit and watch a fishing television program on the television 120. The content system 250 may receive part or all of the fishing television program. For example, the television 120 itself may have a microphone that may send audio signals from the fishing program to the content system 250, such as via a network 205. The content system 250 may determine or recognize that the user 110 also owns, operates, or has registered or logged-in a laptop 130. The content system 250 may search for additional content related to the fishing program being broadcast on the television 120. In some instances, the content may be campaign content. For example, the additional content may be an advertisement for a fishing pole or tackle. In other instances, the content may be other content, such as content from one or more databases or stores of data or information. For example, the additional content may be an article on fishing published by a national newspaper or magazine. The content system 250 may then transmit the additional content to the laptop 130. The laptop 130 may display the additional information to the user 110. In this way, the content system 250 may provide an enhanced viewing experience for a user 110 by providing relevant and additional content to a user on a second device (the laptop 130) based on content that the user 110 is viewing or receiving from a first device (the television 120). Various other variations and examples are possible.

Some methods and systems may be configured to provide content to users. The systems may include a campaign database that may be configured to store a set of advertising campaigns, such as advertising campaigns for advertisers. Each advertising campaign may include one or more advertisement. Advertisers may associate or bid on one or more auctions of a content system 250. In some systems, a bid of the advertiser may be associated with a possible content characteristic. As an example, an auction may be run for a keyword or phrase that may appear in content to be viewed by a user. In this example, the bid may for the auction may be associated with the keyword bid on, which may represent the possible content characteristic. Other possible content characteristics are possible, such as various user types, content types, display types, or timing information.

The system may also include a matching component, such as matching component 330. The matching component may be configured to identify an actual content characteristic of a content displayed with a first device. For example, the matching component 330 may receive and identify a content displayed on a television 220 displaying content to a user 210. The content may have one or more actual content characteristics, such as a topic, time or date of display, and information about the user. The matching component 330 may identify the actual content characteristics in various ways, such as through or using a text generator or information stored about known contents.

The matching component may be configured to compare the actual content characteristic of the content to the possible content characteristics that the user bid on. The matching component 330 may select an optimal advertising campaign from the set of advertising campaigns based on the comparison. For example, the matching component 330 may determine if the actual content characteristics match the possible content characteristics of the auction, and may select an optical advertising campaign associated with a winning bid for the auction if the actual content characteristics match the possible content characteristics. The optimal advertising campaign may be or include the advertising campaign with the highest bid associated with the possible content characteristic matching the actual content characteristic. The matching component 330 may transmit the advertisement of the selected optimal advertising campaign to a second device of the user for display.

In some systems, the possible content characteristics may be or include a keyword or phrase that should be displayed or broadcast with the first content. In some systems, the actual content characteristic may be or include a textual representation of the content. The possible content characteristic may be considered to match the actual content characteristic, in some systems, when the textual representation includes the keyword or phrase. In some systems, the advertisement may be displayed on the second device when the keyword or phrase is displayed with the first device, such as simultaneously, contemporaneously, or before or after the keyword or phrase is displayed. Various other examples and variations are possible.

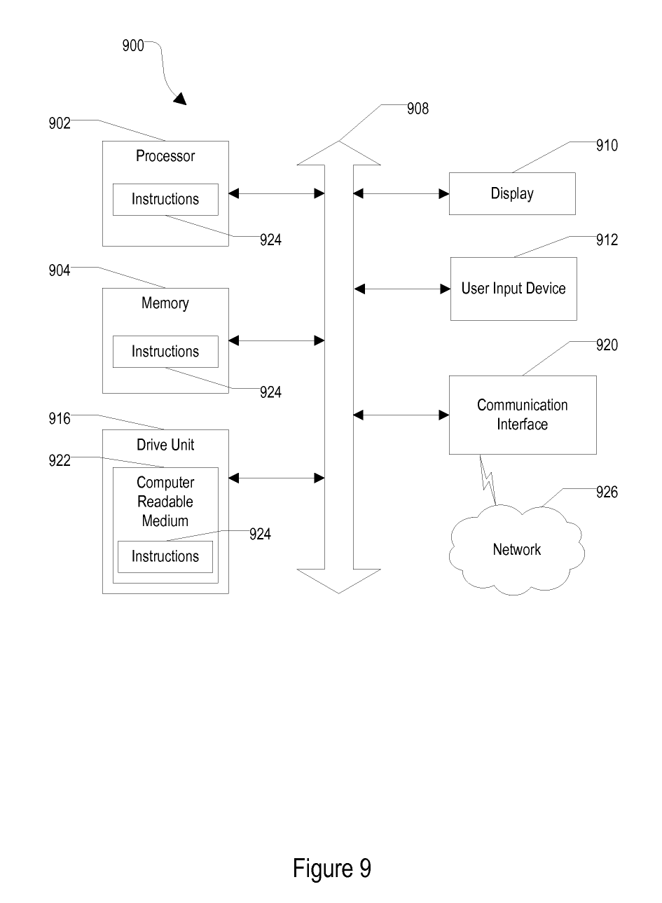

One or more of the computing electronic devices 120, 130, 220, and 230, content sources 240, 245, 440A-440N and 445A-445N, content system 250, cataloguing component 310, source database 320, matching component 330, additional content database 340, campaign database 440, and text generator 510 may be or include one or more computing devices of various kinds, such as the computing device described below in conjunction with FIG. 9. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, an electronic device such as the laptop 130 or tablet 230 may employ the Hypertext Transfer Protocol (“HTTP”) to request information, such as a web page, from a web server, which may be a process executing on, with, or through the content system 250.

The computer system 900, which may be used by or with one or more electronic devices, content sources, content systems or components of content systems, databases, or text generators, may include a set of instructions that can be executed to cause the computer system 900 to perform any one or more of the methods or computer based functions disclosed herein. The computer system 900 may operate as a standalone device or may be connected, e.g., using a network, to other computer systems or peripheral devices.

A computer system 900 may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A computer system 900 may include or may execute a variety of operating systems, including a personal computer operating system, such as a Windows, iOS or Linux, or a mobile operating system, such as iOS, Android, or Windows Mobile, or the like. A computer system 900 may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A computer system 900 may also include or execute an application to communicate content, such as, for example, textual content, multimedia content, or the like. A computer system 900 may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

In a networked deployment, the computer system 900 may operate in the capacity of a server or as a client user computer in a server-client user network environment, or as a peer computer system in a peer-to-peer (or distributed) network environment. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

The computer system 900 may also or alternatively be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In some systems, the computer system 900 may be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

The computer system 900 may include a processor 902, such as a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some systems, the memory 904 may include a cache or random access memory for the processor 902. In alternative systems, the memory 904 may be separate from the processor 902, such as a cache memory of a processor, the system memory, or other memory. The memory 904 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 904 may be operable to store instructions executable by the processor 902. The functions, acts or tasks illustrated in the figures or described herein may be performed by the programmed processor 902 executing the instructions stored in the memory 904. The functions, acts or tasks may be independent of the type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 900 may further include a display unit 910, such as a liquid crystal display (LCD), an organic light emitting diode (OLED), a flat panel display, a solid state display, a cathode ray tube (CRT), a projector, a printer or other now known or later developed display device for outputting determined information. The display 910 may act as an interface for the user to see the functioning of the processor 902, or specifically as an interface with the software stored in the memory 904 or in the drive unit 916.

Additionally or alternatively, the computer system 900 may include an input device 912 configured to allow a user to interact with any of the components of system 900. The input device 912 may be a number pad, a keyboard, or a cursor control device, such as a mouse, or a joystick, touch screen display, remote control or any other device operative to interact with the computer system 900.

The computer system 900 may also include a disk or optical drive unit 916. The disk drive unit 916 may include a computer-readable medium 922 in which one or more sets of instructions 924 or software, can be embedded. Further, the instructions 924 may embody one or more of the methods or logic as described herein. In some systems, the instructions 924 may reside completely, or at least partially, within the memory 904 and/or within the processor 902 during execution by the computer system 900. The memory 904 and the processor 902 also may include computer-readable media as discussed above.

The computer-readable medium may include instructions 924 or receive and execute instructions 924 responsive to a propagated signal so that a device connected to a network 926 may communicate voice, video, audio, images or any other data over the network 926. Further, the instructions 924 may be transmitted or received over the network 926 via a communication port or interface 920, and/or using a bus 908. The communication port or interface 920 may be a part of the processor 902 or may be a separate component. The communication port 920 may be created in software or may be a physical connection in hardware. The communication port 920 may be configured to connect with a network 926, external media, the display 910, or any other components in system 900, or combinations thereof. The connection with the network 926 may be a physical connection, such as a wired Ethernet connection or may be established wirelessly as discussed below. Likewise, the additional connections with other components of the system 900 may be physical connections or may be established wirelessly. The network 926 may alternatively be directly connected to the bus 908.

While the computer-readable medium may be described as a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The “computer-readable medium” may be non-transitory, and may be tangible.

In one example, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The network 926 may be the same, similar to, included in, or overlap network 205. The network 926 may couple devices so that communications may be exchanged, such as between a server and a client device or other types of devices, including between wireless devices coupled via a wireless network, for example. The network 926 may also include mass storage, such as network attached storage (NAS), a storage area network (SAN), or other forms of computer or machine readable media, for example. The network 926 may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

The network 926 may be wired or wireless networks. A wireless network may couple client devices with a network. A wireless network may employ stand-alone ad-hoc networks, mesh networks, Wireless LAN (WLAN) networks, cellular networks, an 802.11, 802.16, 802.20, or WiMax network. Further, the network 926 may be a public network, such as the Internet, a private network, such as an intranet, or combinations thereof, and may utilize a variety of networking protocols now available or later developed including, but not limited to TCP/IP based networking protocols.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via the networks 205 and 926, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet may include local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

The network 926 may be or include a content distribution network. A “content delivery network” or “content distribution network” (CDN) may refer to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

The network 926 may be or include a peer-to-peer network. A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

The network 926 may be or include a social network. The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionality as described herein.

In auction-based implementations, winning bids may be selected or determined in various ways. In some systems, a winning bid may be a bid with a highest value or monetary amount. In some systems, a winning bid may be a bid associated with a highest quantity or amount. In some systems, a winning bid may be a bid associated with a trustworthy or credible bidder, a bidder with a high credit score or financial rating, or a bidder with a favorable account history. In some systems, a winning bid may be a bid from an advertiser or content provider who has been profitable or partnered with the content system 250. In some systems, a winning bid may be based on these or any other combination of factors.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. Accordingly, the invention is not to be restricted except in light of the attached claims and their equivalents.

We claim:

1. A computer-implemented method of serving advertisements to a device, comprising:
identifying a characteristic of a content displayed with a first device;
comparing, through the use of a processor, the characteristic of the content with a campaign constraint of an advertising campaign, the advertising campaign including an advertisement;
transmitting the advertisement to a second device for display when the characteristic of the content satisfies the campaign constraint.

2. The method of claim 1, where the characteristic of the content includes a textual representation of the content.

3. The method of claim 2, where the campaign constraint includes a keyword; and
where the characteristic of the content satisfies the campaign constraint when the textual representation of the content includes the keyword.

4. The method of claim 1, where the first device and the second device are configured to display to the same user.

5. The method of claim 1, where an advertiser associated with the advertising campaign bids to have the advertisement displayed when the keyword appears in the textual representation of the content.

6. A system for providing content, comprising:
a campaign database configured to store a set of advertising campaigns, each advertising campaign including an advertisement and a bid associated with a possible content characteristic;
a matching component configured to identify an actual content characteristic of a content displayed with a first device; and
where the matching component is configured to compare the actual content characteristic to the possible content characteristics, select an optimal advertising campaign from the set of advertising campaigns based on the comparison, and transmit the advertisement of the selected optimal advertising campaign to a second device for display.

7. The system of claim 6, where the optimal advertising campaign includes the advertising campaign with the highest bid associated with a possible content characteristic matching the actual content characteristic.

8. The system of claim 7, where the possible content characteristic includes a keyword or phrase;
where the actual content characteristic includes a textual representation of the content; and
where possible content characteristic matches the actual content characteristic when the textual representation includes the keyword or phrase.

9. The system of claim 8, where the advertisement is displayed on the second device when the keyword or phrase is displayed with the first device.

10. The system of claim 6, where the matching component receives a digital representation of the content displayed with the first device from the second device; and
where the matching component uses the digital representation of the content to identify an actual content characteristic of the content.

11. The system of claim 6, further comprising a source database configured to store a set of known contents, each known content including a known content characteristic.

12. The system of claim 11, where the matching component identifies the actual content characteristic by comparing the content displayed with the set of known contents, where the actual content characteristic includes a known content characteristic of a known content that matches the content displayed.

13. A system comprising a non-transitory computer readable storage medium having stored therein data representing instructions executable by a programmed processor for providing content, the storage medium comprising:
instructions for storing a set of content campaigns, each content campaign including an additional content and at least one campaign constraint for displaying the additional content;
instructions for gathering a first content and at least one first content factor associated with the first content, the first content displayed with a first device;
instructions for comparing the at least one first content factor with the at least one campaign constraint of the content campaigns;
instructions for selecting an optimal content campaign based on the comparison, the at least one campaign constraint of the optimal content campaign being satisfied by the at least one first content factor;
transmitting the additional content of the optimal content campaign to a second device for display.

14. The system of claim 13, where the first content factor is a textual description of the first content, a closed-captioning description of an audio portion of the first content, or a transcript of the audio portion of the first content.

15. The system of claim 14, where the at least one campaign constraint requires inclusion of one or more keywords in the textual description, the closed-captioning description, or the transcript of the first content.

16. The system of claim 13, where the content campaign is an advertisement campaign and the additional content of the optimal content campaign is an advertisement.

17. The system of claim 13, where information about the first content is received from a microphone.

18. The system of claim 13, further comprising instructions for identifying the second device as being related to the first device prior to transmitting the additional content of the optimal content campaign to the second device for display.

19. The system of claim 18, where the second device is identified as being related to the first device when the first device and the second device are both associated with an account, a log-in, or a registration.

20. The system of claim 18, where the first device is a television; and
where the second device is a computer, tablet, or mobile device.
